(19) United States
(12) Patent Application Publication
(10) Pub. No.: US 2002/0120631 A1
(43) Pub. Date: Aug. 29, 2002

(54) Taxonomic classification system and method

(76) Inventor: Arthur Conroy, Charlottesville, VA (US)

Correspondence Address: RABIN & CHAMPAGNE, PC, 1101 14TH STREET, NW, SUITE 500, WASHINGTON, DC, 20005, US

(21) Appl. No.: 09/843,643

(22) Filed: Apr. 27, 2001

Related U.S. Application Data
(60) Provisional application No. 60/270,634, filed on Feb. 23, 2001.
(60) Provisional application No. 60/276,475, filed on Mar. 19, 2001.

(51) Int. Cl. G06F 7/00

(52) U.S. Cl. 707/104.1

(57) ABSTRACT

A taxonomic classification system includes a user computer, server, and optional register, which are networked together. A server contains data earmarked to be sent to the user, and server data. A user agent requests a server agent to send to the user computer a portion of the earmarked data or the server data that is covered by, or matches, the user's classification data. A register includes a database containing user and server classification data and optional respective reference data. The user agent or sever agent query the database through the register agent, which sends back user classification data, server classification data and/or respective reference data in response to the query.

### RELATED APPLICATIONS

This application claims the priority benefit under 35 U.S.C. §119 of the following: Provisional Patent Application Ser. No. 60/270,634 filed on Feb. 23, 2001, entitled: “TOPIK SOLUTION;” and Provisional Patent Application Ser. No. 60/276,475 filed on Mar. 19, 2001, entitled: “TOPIK SOLUTION.”

### FIELD OF INVENTION

The present invention relates to the organization, storage and retrieval of information through the use of computers; and more particularly, to a taxonomic classification system and method for use with a computer network.

### BACKGROUND OF THE INVENTION

A computer network communicatively connects a plurality of computers to each other. The network may be hard-wired, wireless or a combination thereof. Each computer connected to the network may have data stored in respective memory that is accessible to other computers connected to the network. Therefore, the amount of data accessible via the network by a particular computer connected to the network may be substantial. The Internet is a network having a substantial amount of data accessible by a particular computer connected to the network. An intranet may be a network having a substantial amount of data accessible by a particular computer connected to the network.

The cost of accessing a substantial amount of data over the network may be significantly high. For example, searching or browsing a substantial amount of data over the network may inefficiently consume bandwidth, resources and time. Therefore, it would be desirable to provide a taxonomic classification system and method to improve the efficiency of accessing data over a network.

### SUMMARY OF THE INVENTION

A taxonomic classification system includes a user computer, a server, and optionally, a register, which are communicatively connected together via respective network interfaces.

The user computer has a CPU, computer memory, an input device, an output device, and a network interface, which are operatively connected to each other by at least one bus. A UTV and a user agent are stored in the memory of the user computer. A UTV includes one or more taxonomic classifications associated with a user, and may be dynamically created, or retrieved from the user computer memory or from another computer on the network. A user agent interacts with the user via the user computers input and output devices, and is adapted to send a UTVR over the network. The user agent is optionally adapted to send a STVQ, a CTVR, a CTVQ or a SMUTVR over the network.

The server has a CPU, a memory, and a network interface, which are operatively connected to each other by at least one bus. Stored in the server memory are one or more data objects that are earmarked to be sent to the user, and a server agent that is adapted to receive and process the UTVR. Optionally stored in server memory are one or more data structures that are accessible by the user computer; an STV having one or more taxonomic classifications representing the one or more data structures; for each of the one or more server taxonomic classifications, reference data to reference the one or more data structures represented by a respective server taxonomic classification. The server agent is optionally adapted to receive and process the STVQ, the CTVR and the CTVQ sent by the user agent, and to send a UMSTVR over the network.

The optional register includes a CPU, a memory, and a network interface, which are operatively connected to each other by at least one bus. Stored in the register memory are the UTV, the STV, and a register agent that is adapted to receive and process the SMUTVR sent by the user agent and the UMSTVR sent by said server agent.

### BRIEF DESCRIPTION OF THE DRAWINGS

FIG. 1 illustrates an overview of a taxonomic classification system having a user computer, a server and an optional register communicatively connected to each other via a computer network.

FIG. 2 shows an exemplary embodiment of a user computer.

FIG. 3 shows an exemplary embodiment of a server.

FIG. 4 illustrates sources from which earmarked data objects are received by a server.

FIG. 5 illustrates an exemplary embodiment of a server agent sending encapsulated matching data objects to a user agent.

FIG. 6 shows an exemplary embodiment of an optional register.

### DETAILED DESCRIPTION

The invention will now be described in more detail by way of example with reference to the embodiments shown in the accompanying figures. It should be kept in mind that the following described embodiments are only presented by way of example to facilitate disclosure of the invention and to demonstrate enablement, and should not be construed as limiting the inventive concept to any particular feature, aspect or embodiment disclosed.

General Definitions

Computer memory may be embodied in any of several forms, including RAM, ROM, EPROM, PROM, registers, latches, hard drives, CD-ROM, CD-R, any other type of memory storage devices, and/or various combinations thereof.

A computer network comprises a user computer, a server, and optionally a register, which are operatively connected to each other. The network may utilize any known, obvious or future developed protocol or combination of protocols adapted to allow computers connected to the network to communicate with each other. The user computer and server may also utilize any known, obvious or future developed protocol or combination of protocols adapted to allow the user computer, server and optional register to communicate with each other.

A data object contains information. A data object may be any form of data structure, such as a single or multiple packets, e-mail messages, text files and/or binary files, for example and not in limitation.

Information may be organized into and referenced by one or more taxonomic classifications. A taxonomic classification may be made by subject matter, author, title, date, size, importance, expiration date, content rating (e.g., G, PG, R, X, A1, ZK, etc.), any known or obvious logic, association, or grouping (e.g., the number of .pdf files, the top ten most popular classifications, LRU, MRU, a single or multiple database query, etc.), or any other type of taxonomic classification. A taxonomic classification may be a taxonomic sub-classification. For example and not in limitation, where “motorcycles” is a classification, “HARLEY™ motorcycles” may be a taxonomic sub-classification as well as a taxonomic classification. Also, for example and not in limitation, where a database query is a classification, an iterative query (where each successive query operates on the result of the previous query, resulting in a series of smaller data sets being queried) may be a taxonomic sub-classification as well as a taxonomic classification.

Discussion

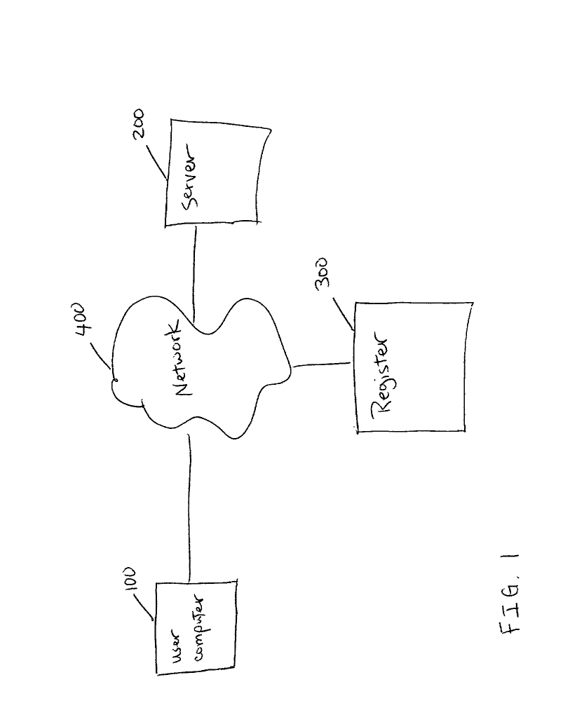

Initial reference is made to FIG. 1, which illustrates an overview of a taxonomic classification system according to the present invention, in which a user computer 100, a server 200 and an optional register 300 are communicatively connected to each other via a computer network 400, such as the Internet, for example and not in limitation. The computer network 400, including user computer 100, server 200 and register 300, may be hard-wired (connected by a physical medium; e.g., cable, fiber, etc.), wireless or a combination of both.

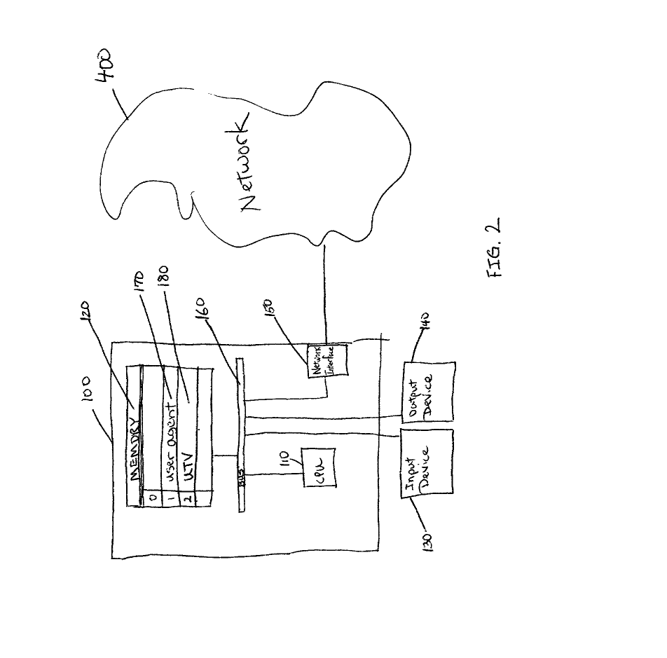

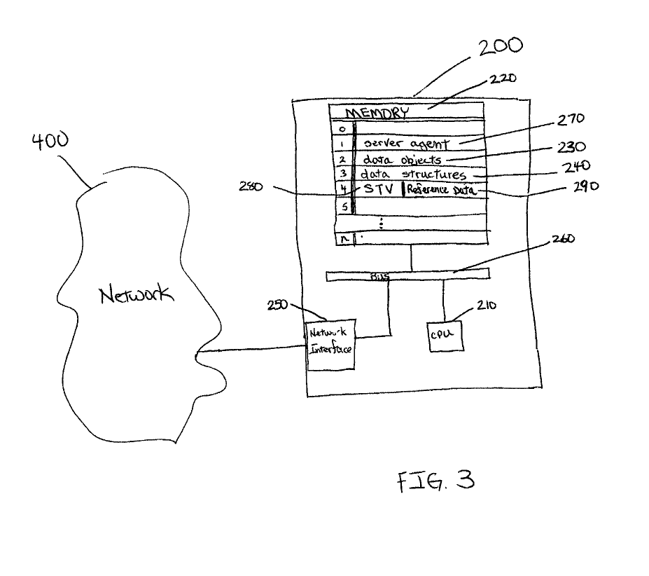

FIG. 2 shows an exemplary embodiment of a user computer 100 according to an aspect of the present invention, in which the user computer comprises a user computer CPU 110, user computer memory 120, a user computer input device 130, a user computer output device 140 and a user computer network interface 150, which are operatively connected to each other by at least one user computer bus 160. A user agent 170 is stored in the user computer memory 120. A user (not shown) interacts with a user agent 170, and a user agent interacts with a server agent (shown in FIG. 3), both according to any part, all or obvious variations of the disclosure herein. The user agent 170 may provide any type of known or obvious user interface, such as a graphical user interface (“GUI”). The user computer input device 130 and user computer output device 140 are utilized by the user to operate the user computer 100 and to interface with user agent 170. User computer 100 is connected to network 400 via user computer network interface 150, and is adapted to being operated by a user. Optionally, a UTV 180 (discussed in further detail below) may be stored in the user computer memory 120.

FIG. 3 shows an exemplary embodiment of a server 200 according to an aspect of the present invention, in which a server comprises a server CPU 210, server computer memory 220 and a server network interface 250, which are operatively connected to each other by at least one server bus 260. Server 200 is connected to network 400 via server network interface 250. A server agent 270 is stored in server memory 220. Server memory 220 may optionally store one or more data objects 230 that are earmarked to be sent to the user; one or more data structures 240 that are accessible by user computer 100; an STV 280 having one or more associated taxonomic classifications that represent one or more of the data structures 240; and/or for each of the one or more taxonomic classifications associated with STV 280, STV reference data 290 associating a respective taxonomic classification with a data structure 280 represented by the respective taxonomic classification.

The quality of being earmarked includes, but is not limited to, being addressed to a user, being organized to be sent to a user (queued, stacked), being ready to be sent to a user, being ready to be sent to a user immediately following a request to be sent, being sorted based on a user, and/or any other known or obvious way of reserving, assigning, or allocating data such that it may be discerned that the data is to be sent to a specific user, group of users, or location (computer or device peripheral to a computer).

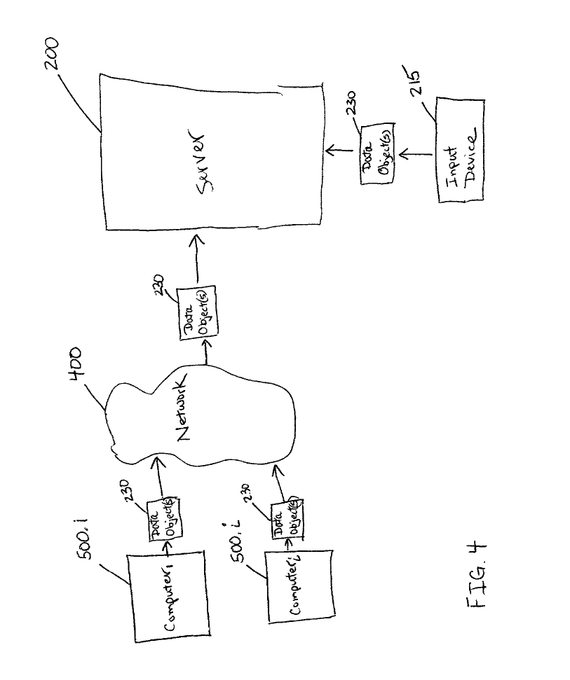

As shown in FIG. 4, data objects 230 may be received by the server 200 from one or more other computers (not shown) connected to the network 400, or from direct input at the server, in which case the server further comprises a server input device (such as a keyboard, pointing device, disk drive, CD-ROM, etc.) operatively connected to the at least one bus 260 of the server.

A user-topik-view (“UTV”) 180 is associated with the user. A UTV 180 comprises one or more taxonomic classifications, which may be included in a UTV by selection of one or more classifications from a predefined set of classifications, created dynamically and/or created randomly. Further, classifications may be deleted or disassociated from a UTV. Selection, creation and/or deletion of a classification may be effected by a third party, a user, a user agent, a server and/or a third server, in whole or in part, and/or independently or in mutual conjunction.

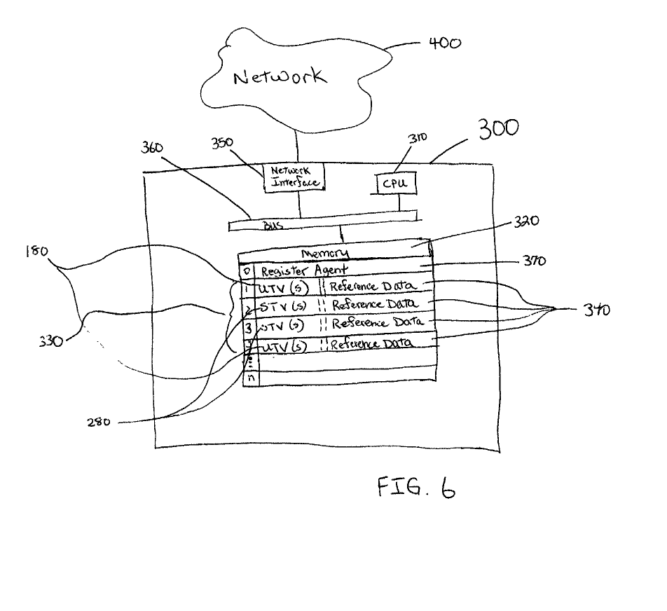

A UTV 180 may be static or dynamic: a UTV may be stored on the user computer 100 (as shown in FIG. 2), stored on the server 200 (not shown), stored on a third computer on the network (e.g., a register, as shown in FIG. 6), or created dynamically. The selecting, creating and deleting of taxonomic classifications may be effected by any known or obvious methodology. For example and not in limitation, a user may select, create and/or delete a classification via the user computer input device 130; for example, interaction with a keyboard, a pointing device, a microphone (voice input), a biometric reader, or other input device, with or without a GUI or other user interface. Other methodology may include computer software-based accessing, selecting, deleting, creating, assigning to a variable, or other operation on a classification in any known or obvious way consistent with this disclosure, including but not limited to any known or obvious artificial intelligence, logic or random methodology for operating on the classification.

Via the user computer 100, the user may send to a server a user-topik-view-request (“UTVR”), which requests the server to send to the user the data objects 230 according to the user's associated UTV 180. A UTVR is processed by the server agent 270, which sends to the user those earmarked data objects 230 that match at least one of the taxonomic classifications associated with the user's UTV 180. The earmarked data objects 230 that do not match the taxonomic classifications associated with the UTV 180 may be discarded or retained by the server agent 270 disposed on the server 200 or on a third computer on the network. The data objects 230 that match at least one taxonomic classification associated with the user's UTV 180 may be referred to as “matching data objects.”

In another exemplary aspect of the present invention, a user may request a server agent 270 to repeatedly and/or automatically process the user's UTV 180 against one or more sets of data objects 230 earmarked to be sent to the user. For example and not in limitation, a server agent 270 may be requested to process one or more sets of data objects 230 periodically, such as every hour, day, week, etc., for example and not in limitation; on the occurrence of an event, such as each time a new data object is received by the server 200, each time the user visits the server or each time the user logs into the network 400; randomly; in any known or obvious way or at any conceivable time interval; and/or in various combinations thereof.

A server agent 270 may send the matching data objects to the user computer 100 in any format understandable by the user agent 170, including through the use of a translation process or instrument. For example and not in limitation, the matching data objects may be grouped or associated according to the taxonomic classifications in the UTV 180, with or without removing duplicates. The server agent 270 may also send formatting information, such as taxonomic classifications, data values associated with taxonomic classifications, end of data object markers, end of group of data object markers and/or any other known or obvious formatting information.

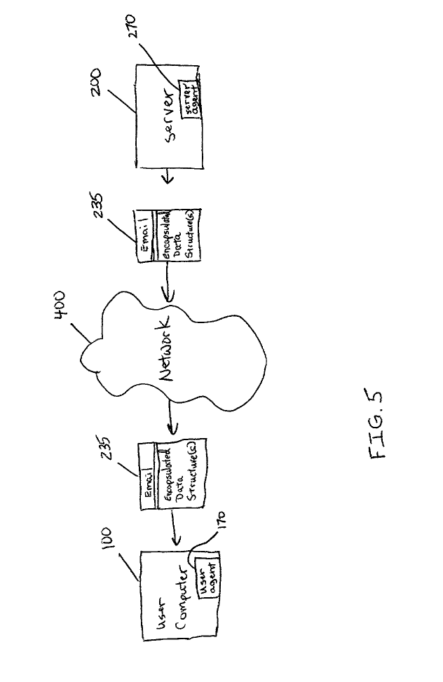

FIG. 5 illustrates another exemplary aspect of the present invention, in which a server agent 270 may encapsulate the matching data objects in one or more encapsulated data structures 235, such as an e-mail message, for example and not in limitation, and send the encapsulated data structures 235 over the network 400 to a user agent 170.

In yet a further exemplary aspect of the invention, a server agent, server administrator or third party may generate statistical data based on the one or more data objects 230 earmarked to be sent to a user, and send the statistical data over the network 400 to user agent 170, a second server agent 270, and/or a register agent.

Server 200 may have a server-topik-view 280 (“STV”) associated therewith. An STV 280 comprises one or more taxonomic classifications representing the one or more data structures 240 stored in the server memory 220 that are accessible to the user computer 100. The data structures 240 stored in the server memory 220 may contain raw data, statistical data, web pages, images, sounds, animations, text files, binary files and/or any other type of data representing information, including multimedia objects incorporating two or more of these types of data.

Taxonomic classifications may be included in or associated with an STV 280 by selection of one or more classifications from a predefined set of classifications, created dynamically and/or created randomly, or based on a classification of the data structures 240 stored in the server memory 220. Further, classifications may be deleted or disassociated from an STV 280, such as when classifications is no longer represented by a data structure 240 stored in server memory 220 or for any other desired reason, for example and not in limitation. Selection, creation, deletion and/or other operation on these classifications may be by a server administrator (not shown), a server agent 270 or a third party (not shown), in whole or in part, and/or independently or in mutual conjunction. A determination as to which classifications are represented by data structures 240 stored in server memory 220 may be performed by a server administrator (not shown), a server agent 270 or a third party granted access and authorization to do so (not shown). A determination made by a human may be accomplished by obvious means. A determination made by a computer may involve a process including any known or obvious artificial intelligence or data evaluation methodology, including but not limited to, context-based language evaluation, statistical evaluation or content evaluation. For example and not in limitation, a computer may evaluate one or more words within a data structure, a data structure type, a data structure size, or any other logical or intuitive evaluation of a data structure, to definitions or descriptions of taxonomic classifications that are known or created.

For each classification included in or associated with an STV 280, indexes, pointers, or any other form of referencing data (which includes a referencing function) may be included to reference the data structures 240 stored in the server memory 220 that belong to the classification.

A user, through the user agent 170, may send to a server 200 a server-topik-view-query (“STVQ”), which requests a server agent 270 to send to the user agent 130 the server's STV 280 for review by the user. The user agent 170 may communicate the classifications included in or associated with the STV 280 to the user so that the user may determine whether to access the data structures 240 stored in the server memory 220.

A user, through the user agent 170, may send to a server 200 a combined-topik-view-query (CTVQ), which requests the server agent 270 to send to the user the classifications included in or associated with the server's STV 280 that match the user's UTV 180. For a CTVQ, a server agent 270 may receive the user's UTV 180 from the user agent 170, a third computer on the network (e.g., a registration server, or other computer on the network), or from the server memory 220. The user agent may send to server 200 state data that includes UTV 180 (e.g., a cookie) prior to the processing of the CTVQ by server agent 270.

A user, through the user agent 170, may send a server 200 a combined-topic-view-request (“CTVR”), which requests a server agent 270 to send to the user the data structures 240 stored in server memory 220, or one or more hyperlinks, pointers, indexes, addresses, etc., thereto, which correspond to the classifications common to the user's UTV 180 and the server's STV 280. For a CTVR, a server agent 270 may receive the user's UTV 180 from user agent 170, a third computer on the network (e.g., a registration server, or other computer on the network), or from server memory 220. The user may send to server 200 state data including UTV 180 (e.g., a cookie) prior to the processing of a CTVR by server agent 270.

FIG. 6 shows an exemplary embodiment of an optional register 300 according to an aspect of the present invention, in which a register comprises a register CPU 310, register computer memory 320 and a register network interface 350, which are operatively connected to each other by at least one register bus 360. The register 300 is connected to the network 400 via the register network interface 350. A register agent 370 is stored in register memory 320. The register memory 320 may also include a database 330 containing one or more UTVs 180 and/or one or more STVs 280. A register memory 320 may also include “TV reference data” 340 for the stored UTVs 180 and STVs 280 (e.g., IP addresses, URLs, primary keys, pointers, names, email address, or any other known or obvious type of reference data, including reference functions).

Register agent 370 may act as a database engine. Register agent 370 may process and report a plurality of statistical reports and/or any other known or obvious queries regarding database 330. Register agent 370 may establish clearance levels for one or more computers on the network and/or one or more users. A register memory 320 may further contain clearance data associated with computers and/or users. A register agent 370 may allow and/or disallow one or more users or computers on the network 400 to input one or more STVs 280 and/or UTVs 180 into the register memory 320. A register agent 370 may allow or disallow one or more users or other computers on the network 400 to browse and/or search STVs 280 and/or UTVs 180 stored in the register memory 320. A register agent 370 may provide a user interface, such as a GUI, for entering, deleting, browsing and/or searching STVs 280 and/or UTVs 180.

A user, through user agent 170, may send to a register 300 a server-match-user-topik-view-request (“SMUTVR”), which requests a server agent 370 to send to the user the reference data 340 of STVs 280, and/or the STVs 280 themselves, that match some or all of the classifications included in or associated with the user's UTV 180. For an SMUTVR, a register agent 370 may receive the user's UTV 180 from the user agent 170, another computer on the network 400, for example, a second register (not shown), or from the register memory 320. The user may send to register 300 state data that includes UTV 180 (e.g., a cookie) prior to the processing of a SMUTVR by a register agent 270.

A server agent 270 may send to register 300 a user-match-server-topik-view-request (“UMSTVR”), which requests a register agent 370 to send to the server agent 270 the TV reference data 340 of UTVs 180, and/or the UTVs themselves, that match some or all of the classifications included in or associated with the server's STV 280. For an UMSTVR, a register agent 370 may receive the server's STV 280 from the server agent 270, another computer on the network 400, for example, a second register (not shown), or from the register memory 320. The server agent may send to register 300 state data that includes STV 280 (e.g., a cookie) prior to the processing of a UMSTVR by a register agent 270.

The invention has been described in detail, with reference to one or more exemplary embodiments. It should be understood, however, that the invention is not necessarily limited to the specific processes and arrangements shown and described above, but may be amenable to numerous variations within the scope of the invention. For example, although the above-described exemplary aspects of the invention are believed to be particularly well suited for a single user, single server and single register, it is contemplated and intended to be claimed such that the concepts of the present invention are applied to systems and methods involving multiple users, servers and/or registers.

It will be apparent to one skilled in the art that the manner of making and using the claimed invention has been adequately disclosed in the above-written description of the aspects and embodiments taken together with the drawings.

It will be understood that the above description of the embodiments of the present invention are amenable to various modifications, changes and adaptations, and the same are intended to be comprehended within the meaning and range of equivalents of the appended claims.

What is claimed is:

1. A taxonomic classification system comprising:
a user computer comprising a user computer CPU, a user computer memory, a user computer input device, a user computer output device, and a user computer network interface, which are operatively connected to each other by at least one user computer bus, said user computer being operatively connected to a network by said user computer network interface;
a UTV residing in said user computer memory, said UTV comprising one or more user taxonomic classifications associated with a user;
a user agent residing in said user computer memory, said user agent being adapted to interact with the user via said user computer input device and said user computer output device, and being further adapted to send a UTVR, a STVQ, a CTVR, a CTVQ and a SMUTVR over the network;
a server comprising a server CPU, a server memory, and a server network interface, which are operatively connected to each other by at least one server bus, said server being operatively connected to the network via said server network interface;
one or more data objects residing in said server memory, said one or more data objects being earmarked to be sent to the user;
one or more data structures residing in said server memory, said one or more data structures being accessible by said user computer via the network;
an STV residing in said server memory, said STV comprising one or more server taxonomic classifications representing said one or more data structures;
for each of said one or more server taxonomic classifications contained in said STV, an STV reference to reference the one or more data structures represented by the respective server taxonomic classification;
a server agent residing in said server memory, said server agent being adapted to receive and process the UTVR, the STVQ, the CTVR and the CTVQ sent by said user agent, and being further adapted to send a UMSTVR over the network;
a register comprising a register CPU, a register memory, and a register network interface, which are operatively connected to each other by at least one register bus, said register being operatively connected to the network via said register network interface;
a database residing in said register memory, said database comprising a plurality of UTVs and a plurality of STVs; and
a register agent residing in said register memory, said register agent being adapted to receiving and process the SMUTVR sent by said user agent and the UMSTVR sent by said server agent.
